(19) United States
(12) Patent Application Publication
(10) Pub. No.: US 2012/0089371 A1
(43) Pub. Date: Apr. 12, 2012

(54) MEASUREMENT APPARATUS, MEASUREMENT METHOD, TEST APPARATUS AND RECORDING MEDIUM

(75) Inventors: Takahiro YAMAGUCHI, Saitama (JP); Katsuhiko DEGAWA, Saitama (JP); Masahiro ISHIDA, Gunma (JP); Takafumi AOKI, Miyagi (JP)

(73) Assignee: ADVANTEST CORPORATION, Tokyo (JP)

(21) Appl. No.: 12/899,518

(22) Filed: Oct. 6, 2010

(51) Int. Cl. G06F 19/00

(52) U.S. Cl. 702/189

(57) ABSTRACT

Provided is a measurement apparatus that measures a signal under measurement having a waveform pattern that repeats with a predetermined cycle, comprising a sampling section that coherently samples the signal under measurement; and a waveform reconstructing section that reconstructs a partial waveform corresponding to a partial region of the waveform pattern, by arranging in a predetermined order pieces of sampling data corresponding to the partial region of the waveform pattern from among sampling data acquired by the sampling section.

### BACKGROUND

1. Technical Field

The present invention relates to a measurement apparatus, a measurement method, a test apparatus, and a recording medium.

2. Related Art

When sampling a signal under measurement that has a repeating prescribed waveform pattern, a known technique involves using a coherent sampling clock, as shown in Patent Document 1. By rearranging the sampling data acquired using the coherent sampling clock, the original waveform pattern can be reconstructed.
Patent Document 1: US 2007/0118315

To rearrange the sampling data, however, a calculation must be made for each piece of the sampling data acquired with the coherent sampling clock concerning the position of this piece of sampling data in the reconstructed waveform pattern. Therefore, a lot of time is necessary to reconstruct the waveform pattern. In particular, when increasing the time resolution of the measurement, the time necessary for reconstructing the waveform increases greatly due to the increase in the number of pieces of acquired sampling data.

### SUMMARY

Therefore, it is an object of an aspect of the innovations herein to provide a measurement apparatus, a measurement method, a test apparatus, and a recording medium, which are capable of overcoming the above drawbacks accompanying the related art. The above and other objects can be achieved by combinations described in the independent claims. The dependent claims define further advantageous and exemplary combinations of the innovations herein.

According to a first aspect related to the innovations herein, one exemplary measurement apparatus may include a measurement apparatus that measures a signal under measurement having a waveform pattern that repeats with a predetermined cycle, comprising a sampling section that coherently samples the signal under measurement; and a waveform reconstructing section that reconstructs a partial waveform corresponding to a partial region of the waveform pattern, by arranging in a predetermined order pieces of sampling data corresponding to the partial region of the waveform pattern from among sampling data acquired by the sampling section.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows an exemplary configuration of a test apparatus 200 that tests a device under test 300 such as a semiconductor chip.

FIG. 2 shows exemplary sampling data x(k) of the signal under measurement and an exemplary reconstructed waveform y(l).

FIG. 3 shows exemplary sampling data x(k) of the signal under measurement and a reconstructed partial waveform y(l).

FIG. 4 shows an exemplary configuration of the waveform reconstructing section 120.

FIG. 5 shows an exemplary configuration of the jitter calculating section 220.

FIG. 6 shows a plurality of partial waveforms Y_{P}[m].

FIG. 7 shows an exemplary summed waveform Y_{SUM}[m] obtained by adding together a plurality of partial waveforms Y_{P}[m].

FIG. 8 shows an exemplary differential waveform Y_{DIFF}[m].

FIG. 9 shows an exemplary configuration of the sampling section 110.

FIG. 10 shows exemplary operation of the sampling section 110 shown in FIG. 9.

FIG. 11 shows another exemplary configuration of the sampling section 110.

FIG. 12 shows another exemplary configuration of the sampling section 110.

FIG. 13 shows measurement results of a signal by the measurement apparatus 100.

FIG. 14 shows a configuration of a computer 1600.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

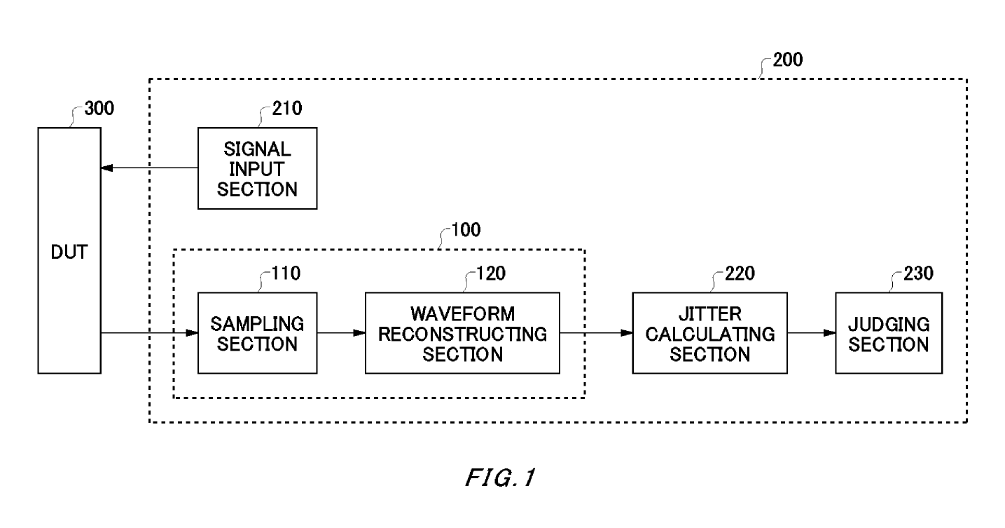

FIG. 1 shows an exemplary configuration of a test apparatus 200 that tests a device under test 300 such as a semiconductor chip. The test apparatus 200 includes a measurement apparatus 100, a signal input section 210, a jitter calculating section 220, and a judging section 230.

The signal input section 210 inputs to the device under test 300 a test signal that causes the device under test 300 to operate. The signal input section 210 of the present embodiment inputs the test signal to the device under test 300 to cause the device under test 300 to output a signal under measurement having a waveform pattern that repeats with a predetermined cycle.

For example, the signal input section 210 may cause the device under test 300 to output a signal under measurement that is a sine wave. Instead, the signal input section 210 may cause the device under test 300 to output a signal under measurement having a waveform pattern represented by a repeating series of bits, such as a PRBS pattern or a designated bit pattern such as ‘1011.’ The test signal may be a trigger signal that causes the device under test 300 to begin outputting the signal under measurement.

The measurement apparatus 100 measures the signal under measurement having the waveform pattern that repeats with the predetermined cycle. The measurement apparatus 100 of the present embodiment measures the signal under measurement output by the device under test 300. The measurement apparatus 100 includes a sampling section 110 and a waveform reconstructing section 120.

The sampling section 110 coherently samples the signal under measurement. Here, the period of the repeating waveform pattern in the signal under measurement is T, and the sampling period is Ts. Furthermore, over M cycles of the signal under measurement, N samples are sampled at even intervals. In other words, T×M=Ts×N.

At this time, if M and N are coprime, the sampling section 110 coherently samples the signal under measurement. The sampling section 110 may under sample or over sample the signal under measurement.

The measurement apparatus 100 may include a comparator that detects the timing at which the level of the signal under measurement transitions from a value less than or equal to a prescribed reference value to a value greater than the reference value. The sampling section 110 may begin sampling with the timing at which the comparator detects the transition of the level of the signal under measurement as a reference.

The waveform reconstructing section 120 generates a partial waveform by rearranging, in a predetermined order, pieces of sampling data corresponding to a partial region of the waveform pattern, from among the sampling data acquired by the sampling section 110. In this way, the waveform reconstructing section 120 reconstructs a partial waveform corresponding to the partial region within the repeating waveform pattern of the signal under measurement.

The waveform reconstructing section 120 may reconstruct such a partial waveform a plurality of times. In this case, the signal measurement apparatus 100 may perform measurement of the signal under measurement a plurality of times over a duration T×M.

The waveform reconstructing section 120 may reconstruct a partial waveform that includes a prescribed edge portion of the waveform pattern. As a result, the timing jitter of this edge portion can be analyzed. The waveform reconstructing section 120 preferably reconstructs a partial waveform that is centered on a position of the edge portion and that includes a region whose length corresponds to the magnitude of the jitter value to be measured.

The waveform reconstructing section 120 may instead reconstruct a partial waveform that does not include a prescribed edge portion of the waveform pattern. As another example, the waveform reconstructing section 120 may reconstruct a partial waveform that includes a plurality of edges of the waveform pattern. For example, the waveform reconstructing section 120 may reconstruct a partial waveform that includes a rising edge and an adjacent falling edge. In this case, the eye opening between the rising edge and the falling edge can be measured.

The waveform reconstructing section 120 may reconstruct two partial waveforms that are separated from each other in the waveform pattern. For example, the waveform reconstructing section 120 may reconstruct a partial waveform for each of two non-adjacent edge portions.

The jitter calculating section 220 calculates the timing jitter of an edge portion of the signal under measurement based on the positional distribution of this edge portion in a plurality of partial waveforms. For example, the jitter calculating section 220 may calculate the peak-to-peak value, the standard deviation, or the like of the positional distribution of the edge portion.

The judging section 230 judges acceptability of the device under test 300 based on the jitter value calculated by the jitter calculating section 220. The judging section 230 may judge the acceptability of the device under test 300 based on whether the jitter value calculated by the jitter calculating section 220 is within a predetermined allowable range.

The measurement apparatus 100 of the present embodiment can reconstruct a partial waveform of a partial region under measurement by using only the sampling data corresponding to the partial region from among the sampling data acquired from the coherent sampling. Therefore, the measurement apparatus 100 can efficiently measure the signal under measurement.

Since the measurement apparatus 100 uses a sampling clock with a prescribed period, the timing error in the sampling clock can be decreased. Specifically, since the delay amount in the variable delay circuit does not need to be controlled to generate the sampling clock, the timing error of the sampling clock can be decreased. Since the N pieces of sampling data correspond to the period T of the waveform pattern, the waveform can be acquired with a time resolution of T/N. Accordingly, the measurement apparatus 100 can quickly calculate the partial waveform with a high time resolution and a low error.

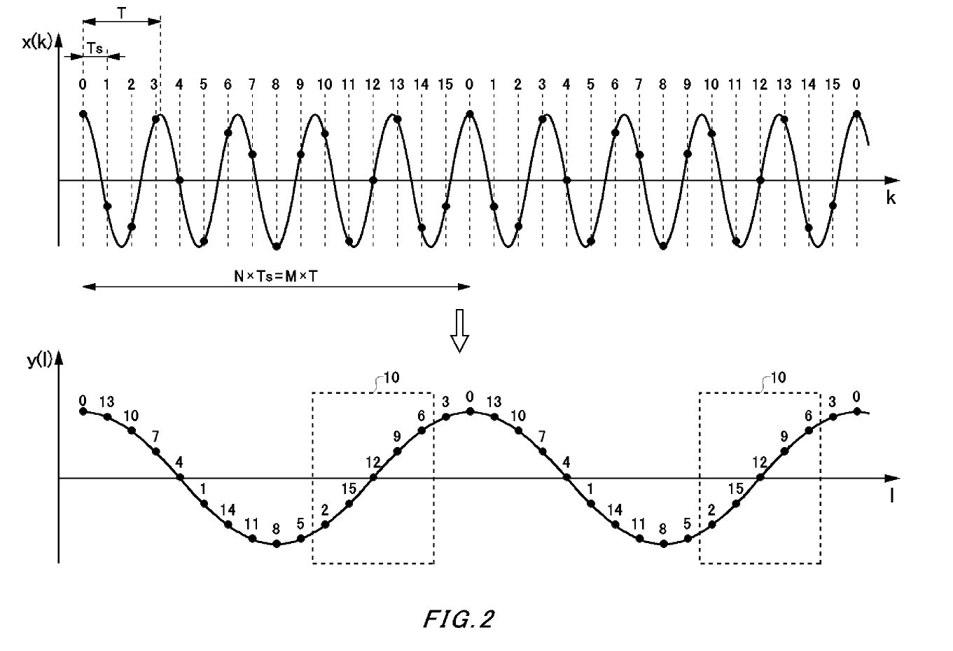

FIG. 2 shows exemplary sampling data x(k) of the signal under measurement and an exemplary reconstructed waveform y(l). FIG. 2 shows a waveform that is obtained by using all of the sampling data of the signal under measurement x(k) to reconstruct a waveform over the entire region of the waveform pattern y(l) of the signal under measurement.

The present example describes a sine-wave signal under measurement x(k). Furthermore, five cycles of the signal under measurement x(k) are sampled using 16 samplings at uniform intervals. In other words, M=5 and N=16.

The index k indicates the order, on the time axis, of a piece of sampling data acquired by the sampling section 110. Here, k is provided as an integer that repeats from 0 to N−1. The index 1 indicates the order, on the time axis, of a piece of sampling data after reconstruction. In FIG. 2, the index k prior to reconstruction is shown adjacent to each piece of data of the reconstructed waveform y(l).

The correspondence between the pieces of sampling data x(k) prior to reconstruction and the pieces of data of the reconstructed waveform y(l) is determined by the expression shown below. Here, σ(k) corresponds to the index 1 of the reconfigured waveform y(l).

σ(k)=1=(k×M)mod N Expression 1

In other words, σ(k) is the bijective map from the set {0, 1, . . . , N−1} to the set {0, 1, . . . , N−1}.

Expression 1 can be used to calculate which piece of reconstructed data each piece of sampling data prior to reconstruction corresponds to. Therefore, the reconstructed waveform pattern y(l) can be obtained by sequentially applying the conversion of Expression 1 to the pieces of sampling data prior to reconstruction.

However, if Expression 1 is used to rearrange all of the pieces of sampling data in an attempt to obtain only a partial waveform, such as an edge portion, of the reconstructed waveform pattern y(l), the computation times becomes undesirably long. The waveform reconstructing section 120 of the present embodiment shortens the computation time by selectively rearranging only the pieces of sampling data included in the partial region 10 of the waveform pattern, which in this case are k=2, 15, 12, 9, 6.

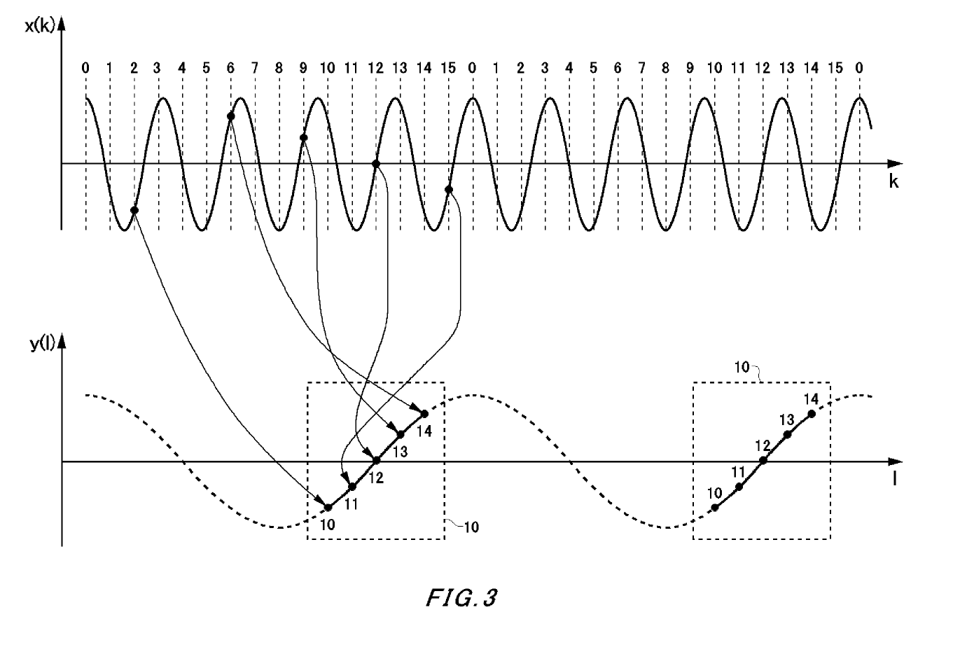

FIG. 3 shows exemplary sampling data x(k) of the signal under measurement and a reconstructed partial waveform y(l). In FIG. 3, the index 1 after reconstruction is shown adjacent to each piece of data of the reconstructed waveform y(l).

The waveform reconstructing section 120 of the present embodiment selects pieces of sampling data corresponding to the region 10 from among the pieces of sampling data x(k), based on information designating the region 10. The information designating the region 10 may designate a range of indexes 1 after reconstruction, which in this example is 1=10 to 1=14.

The waveform reconstructing section 120 selects the pieces of sampling data corresponding to the region 10 from among the pieces of sampling data x(k) prior to reconstruction, and arranges the selected pieces of sampling data in a predetermined order. The waveform reconstructing section 120 calculates the index k prior to reconstruction for each piece of sampling data y(l) corresponding to the region 10, based on the inverse conversion information σ⁻¹ that converts an index 1 after reconstruction into an index k prior to reconstruction, and selects the pieces of sampling data x(k) corresponding to the calculated indexes k.

This inverse conversion information σ⁻¹ is defined as shown below.

$$\begin{matrix}{σ}^{- 1} = ( \begin{matrix}0 & 1 & 2 & … & l & … & N - 1 \\ {k}_{0} & {k}_{1} & {k}_{2} & … & {k}_{l} & … & {k}_{N - 1}\end{matrix} ) & Expression 2 \\ {k}_{1} = ( {M}^{- 1} \times 1 ) mod N & Expression 3\end{matrix}$$

In other words, the inverse conversion information σ⁻¹ converts the index 1 shown in the first row into the index kₗ shown in the second row. Here, kₗ is obtained from Expression 3.

Furthermore, M⁻¹ indicates the multiplicative inverse of M with respect to a denominator N. Here, a value for b that satisfies bc=1(mod n) for a given value c is referred to as the multiplicative inverse of c with respect to the denominator n. It should be noted that the equal sign in this expression indicates congruency. If GCD(c, n)=1, there will always be an inverse of c with n as the denominator. It should be noted that GCD(c, n) represents the greatest common denominator of c and n.

In the present example, M and N are coprime so GCD(M, N)=1, and therefore a multiplicative inverse M⁻¹ of the value M with respect to the denominator N will always exist. Therefore, the inverse conversion information σ⁻¹ for bijectively converting the index 1 into the index k will always exist, and the waveform reconstructing section 120 can select pieces of sampling data x(k) prior to reconstruction that correspond to the region 10 based on the inverse conversion information σ⁻¹.

The multiplicative inverse M⁻¹ of the value M with respect to the denominator N can be calculated from the integers p and q that satisfy the expression M×p+N×q=1. In the present example, M=5 and N=16, and therefore a Euclidean algorithm or the like can be used to obtain the expression 1=16×1+5×(−3). As a result, the multiplicative inverse M⁻¹ is calculated as −3+16=13.

The waveform reconstructing section 120 may be provided in advance with the multiplicative inverse M⁻¹ by a user or the like. Instead, the waveform reconstructing section 120 may be supplied with M and N from a user or the like and then calculate the multiplicative inverse M⁻¹ from M and N. Based on Expressions 2 and 3, the waveform reconstructing section 120 converts the indexes 1 of the reconstructed sampling data in the region 10, which in this case are 1=10 to 1=14, into the indexes k of the sampling data before the reconstruction, which are k=2, 15, 12, 9, 6. As a result, the measurement apparatus 100 can shorten the computation time by selectively rearranging only the pieces of sampling data corresponding to the partial waveform under measurement from among the sampling data prior to reconstruction.

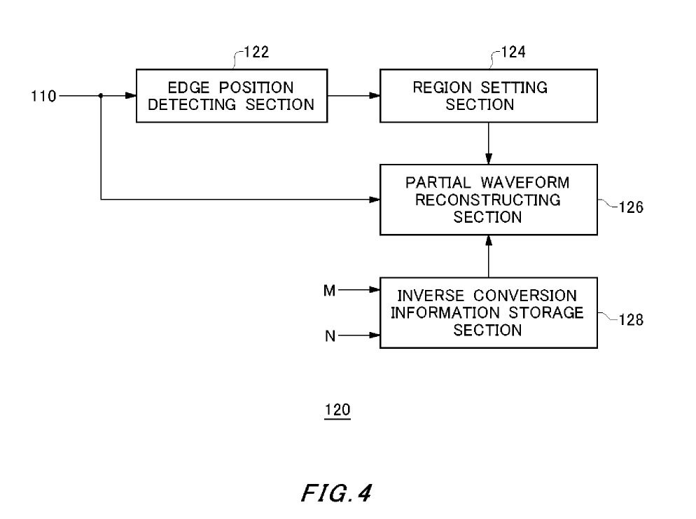

FIG. 4 shows an exemplary configuration of the waveform reconstructing section 120. The waveform reconstructing section 120 of the present embodiment includes an edge position detecting section 122, a region setting section 124, a partial waveform reconstructing section 126, and an inverse conversion information storage section 128.

The edge position detecting section 122 detects the position within a cycle of an edge portion of the waveform pattern of the signal under measurement, based on the sampling data x(k) acquired by the sampling section 110. The edge position detecting section 122 reconstructs the waveform pattern over a region that is longer than the region 10, using a portion of the sampling data x(k) acquired by the sampling section 110. The edge position detecting section 122 of the present embodiment may reconstruct the entire waveform pattern.

The edge position detecting section 122 may detect the position of a prescribed edge portion based on the first N pieces of data in the sampling data x(k). Instead, the edge position detecting section 122 may detect the position of the prescribed edge portion based on the first N×S pieces of data in the sampling data x(k), where S is an integer greater than or equal to 1.

At this time, the edge position detecting section 122 may rearrange the N×S pieces of data according to Expression 1. The edge position detecting section 122 may detect the edge position in each of the S waveform patterns and calculate the average of these edge positions.

The region setting section 124 sets the region 10 that includes the position detected by the edge position detecting section 122. The region setting section 124 of the present embodiment sets a region 10 that includes the position detected by the edge position detecting section 122 and that has a length according to the measurement range of the jitter value contained in the signal under measurement. For example, the edge position detecting section 122 may set the region 10 to be centered at the position detected by the edge position detecting section 122 and to have a length corresponding to the measurement range of the peak-to-peak value or the RMS value of the jitter value. This measurement range may be set by the user, for example.

The inverse conversion information storage section 128 stores the inverse conversion data σ⁻¹ or the multiplicative inverse M⁻¹. The inverse conversion information storage section 128 may calculate the multiplicative inverse M⁻¹ based on M and N provided by the user or the like.

The partial waveform reconstructing section 126 selects the pieces of sampling data x(k) that correspond to the region 10 from among the sampling data x(k) acquired by the sampling section 110, based on the inverse conversion data σ⁻¹. The partial waveform reconstructing section 126 then reconstructs only the partial waveform corresponding to the region 10 in the waveform pattern by rearranging the selected pieces of sampling data x(k) according to the corresponding indexes 1. The method by which the partial waveform reconstructing section 126 reconstructs the waveform is the same as the method used by the waveform reconstructing section 120 described in FIGS. 1 to 3.

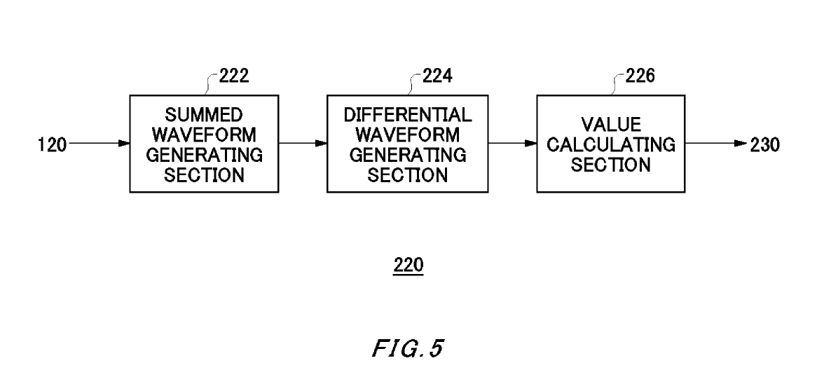

FIG. 5 shows an exemplary configuration of the jitter calculating section 220. The jitter calculating section 220 of the present embodiment includes a summed waveform generating section 222, a differential waveform generating section 224, and a value calculating section 226. The summed waveform generating section 222 generates a summed waveform by adding together a plurality of partial waveforms.

The differential waveform generating section 224 calculates a differential waveform corresponding to the summed waveform. This differential waveform may be obtained by differentiating the summed waveform, for example. The value calculating section 226 calculates the jitter value based on the differential waveform.

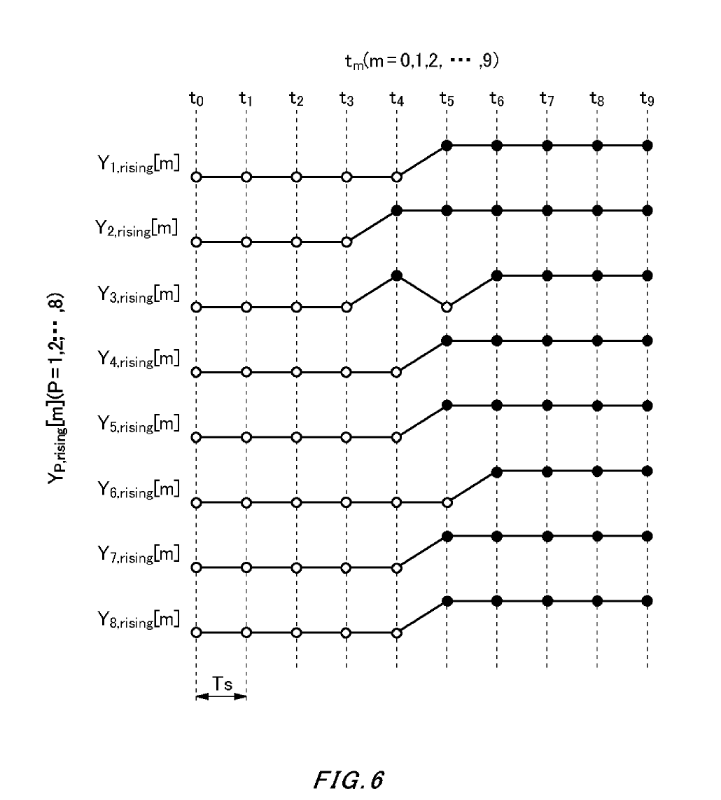

FIG. 6 shows a plurality of partial waveforms Y_{P}[m]. FIG. 6 shows eight partial waveforms Y₁[m] to Y₈[m] that include rising edge portions. In FIG. 6, the indexes of the reconstructed partial waveforms are set to be m=0, 1, 2, . . . , 9. The sampling section 110 in this case is a 1-bit voltage comparator.

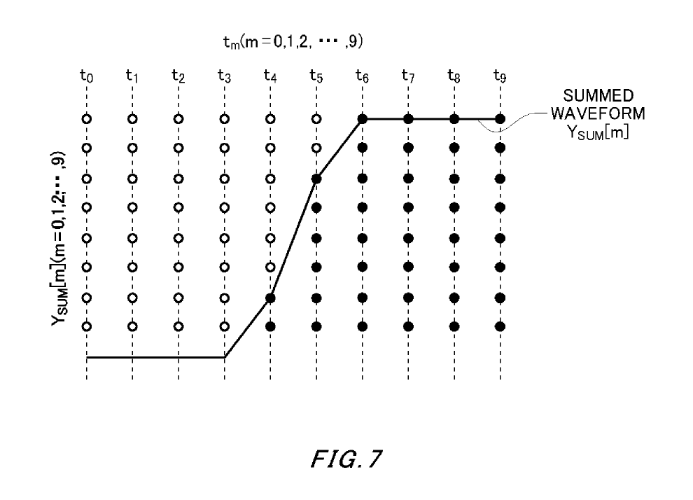

FIG. 7 shows an exemplary summed waveform Y_{SUM}[m] obtained by adding together a plurality of partial waveforms Y_{P}[m]. The summed waveform Y_{SUM}[m] can be calculated by adding together the values of a plurality of partial waveforms Y_{P}[m] for each index m. The sampling section 110 in the present example outputs a binary sequence, and therefore the summed waveform generating section 222 can generate the summed waveform Y_{SUM}[m] by counting the logic values of 1 of the partial waveforms Y_{P}[m] with each index. The summed waveform Y_{SUM}[m] corresponds to the cumulative distribution function CDF of the edge timing of the signal under measurement.

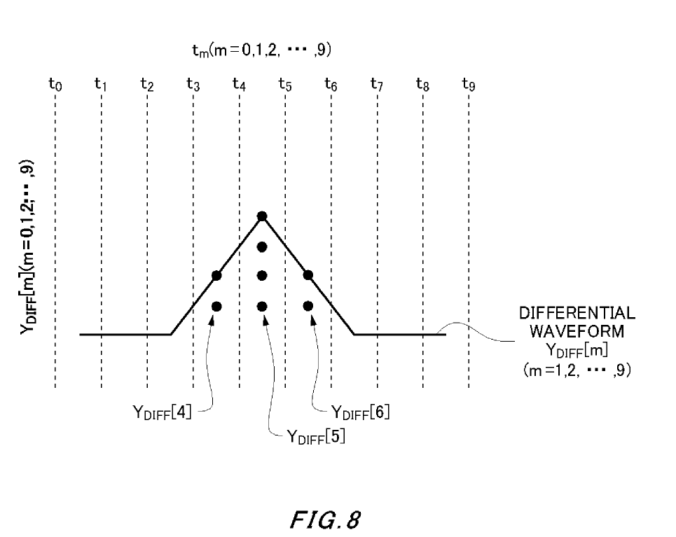

FIG. 8 shows an exemplary differential waveform Y_{DIFF}[m]. The differential waveform generating section 224 may generate the differential waveform Y_{DIFF}[m] by calculating, for each index, the difference between the value of the summed waveform Y_{SUM}[m] at the index m and the value of the summed waveform Y_{SUM}[m] at the index m−1.

Using this process, the differential waveform Y_{DIFF}[m] indicating the timing distribution of an edge portion can be obtained. The value calculating section 226 may calculate the peak-to-peak value, the standard deviation, or the like of the differential waveform Y_{DIFF}[m] based on the standard deviation of the differential waveform Y_{DIFF}[m]. The value calculating section 226 may calculate the random jitter of the signal under measurement based on the standard deviation of the differential waveform Y_{DIFF}[m]. The value calculating section 226 may calculate the deterministic jitter of the signal under measurement based on the peak-to-peak value of the differential waveform Y_{DIFF}[m].

The differential waveform Y_{DIFF}[m] corresponds to the probability density function PDF of the edge timing of the signal under measurement. In this way, the measurement apparatus 100 can perform accurate measurement in a short time by combining a waveform reconstruction technique with coherent sampling by a binary voltage comparator.

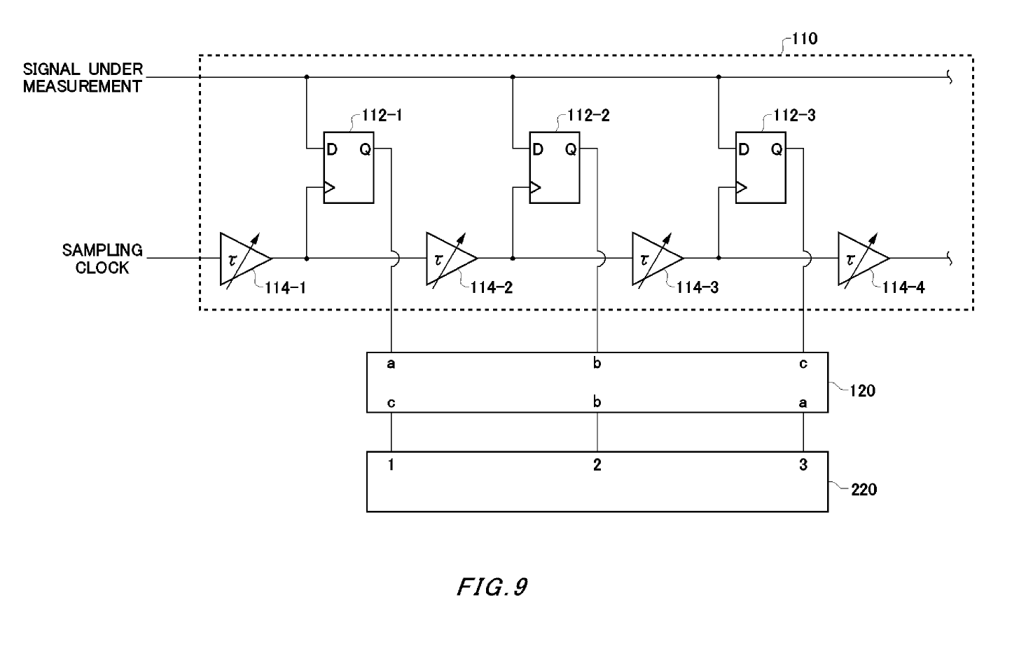

FIG. 9 shows an exemplary configuration of the sampling section 110. The sampling section 110 includes a plurality of flip-flops 112 and a plurality of delay elements 114. The delay elements 114 correspond respectively to the flip-flops 112. The delay elements 114 are connected in cascade and sequentially delay a sampling clock having a prescribed period. Each delay element 114 inputs the delayed sampling clock to the corresponding flip-flop 112.

The flip-flops 112 receive the signal under measurement in parallel and each sample the signal under measurement according to the edge timing of the sampling clock input thereto. The sampling clock input to each flip-flop 112 is sequentially delayed by the delay elements 114, and therefore each flip-flop 112 samples the signal under measurement at a different timing.

FIG. 9 shows flip-flops 112-1 to 112-3, but the sampling section 110 may include more stages of flip-flops. The sampling section 110 may include N flip-flops 112, where N is the value described in relation to FIG. 2. Furthermore, FIG. 9 shows delay elements 114-1 to 114-4, but the sampling section 110 may include more than four stages of delay elements.

The sampling section 110 repeatedly receives the signal under measurement. The sampling clock input to the sampling section 110 may have a period that is coherent with respect to the signal under measurement. For example, the sampling clock may have pulses in cycles corresponding to the number 0, 3, 6, 9, and 12 timings of the sampling timings shown in FIG. 2. Each delay element 114 delays each pulse by a delay amount Ts, thereby enabling the coherent sampling described in relation to FIG. 2 to be performed according to a sampling clock with a low frequency.

Each delay element 114 may be set to have a delay amount T that corresponds to a time resolution Δt, which indicates uniform time intervals of the equivalently sampled data, for measuring the signal under measurement. For example, in FIG. 2, Δt=T/N. The delay amount τ may be expressed as τ=Δt=T/N or as τ=KT+Δt=KT+T/N, where K is 0 or a positive integer. In these cases, the waveform reconstructing section 120 need not rearrange the sampled data.

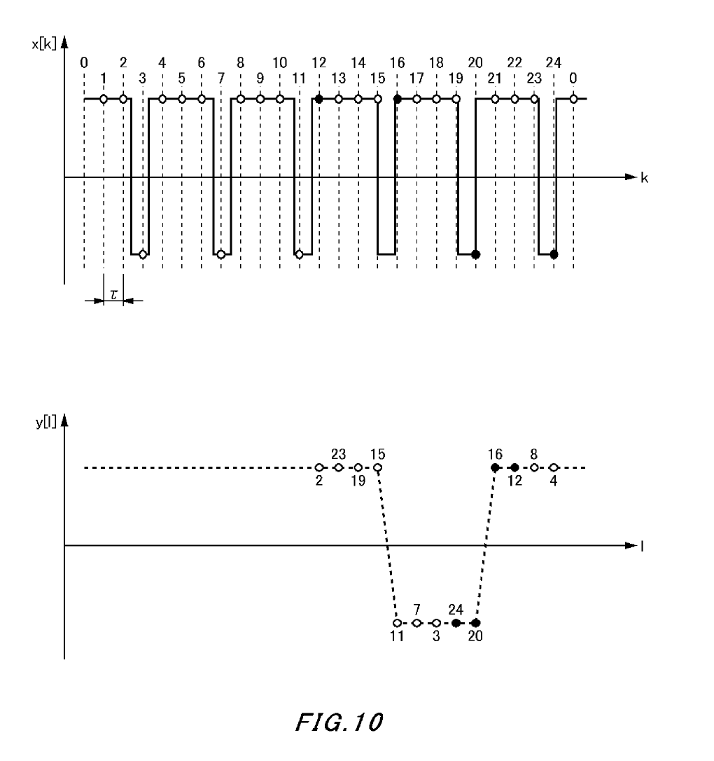

FIG. 10 shows sampling data x(k) and a reconfigured waveform y(l) from the sampling section 110. In the present example, the sampling section 110 performs coherent sampling with M=6 and N=25. The delay amount τ of each delay element 114 may be set as τ=M×T/N. The period of the sampling clock may be set to be the product of the number of flip-flops 112 and the delay amount τ.

The waveform reconstructing section 120 selects the data 12, 16, 20, 24 in the region that includes a rising edge, for example, from among the sampling data x(k) and reconstructs the waveform. With this configuration, the measurement apparatus 100 can use a low-frequency sampling clock to obtain a selective reconstructed waveform.

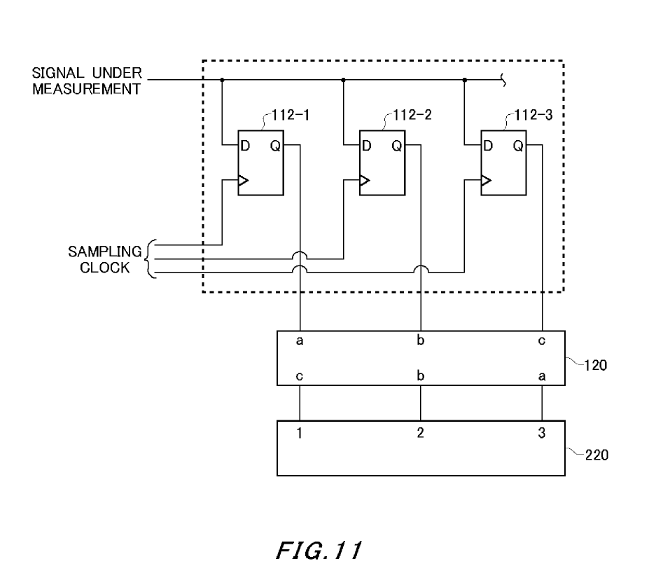

FIG. 11 shows another exemplary configuration of the sampling section 110. The sampling section 110 of the present embodiment includes a plurality of flip-flops 112. The flip-flops 112 each receive a sampling clock with a different timing. Each sampling clock has the same phase relationship as the sampling clock shown in FIG. 9.

Each sampling clock may be generated by one of a plurality of delay elements delaying a single sampling clock, in the same manner as shown in FIG. 9, or may be generated by adjusting the phases of clocks output by a plurality of oscillators. With this configuration as well, the measurement apparatus 100 can use a low-frequency sampling clock to measure the signal under measurement.

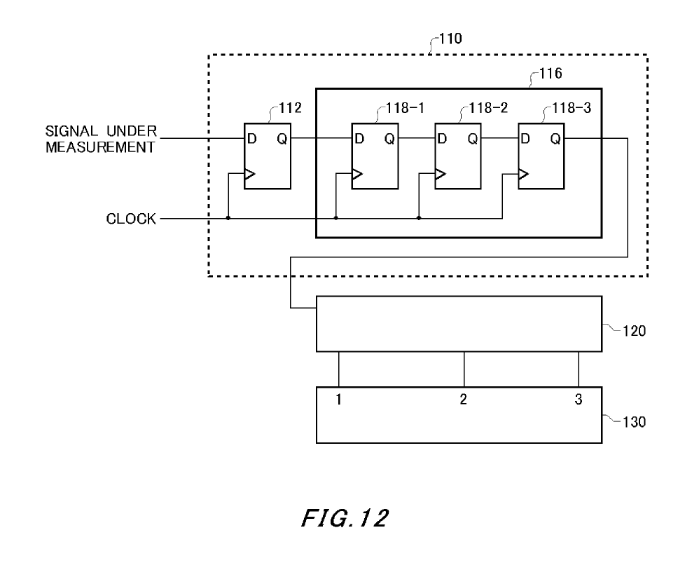

FIG. 12 shows another exemplary configuration of the sampling section 110. The sampling section 110 of the present embodiment further includes a flip-flop 112 and a shift register section 116. The flip-flop 112 performs coherent sampling of the signal under measurement, as described in FIG. 2 or FIG. 10.

The shift register section 116 includes a plurality of flip-flops 118 connected in cascade. Each flip-flop 118 sequentially propagates the sampling data detected by the flip-flop 112, according to a clock input thereto. Each flip-flop 118 receives the same clock as the flip-flop 112. The waveform reconstructing section 120 receives the sampling data sequentially output by the shift register section 116 and reconstructs the waveform.

The waveform reconstructing section 120 reconstructs the waveform such that the sampling results input in the order “a, b, c” are arranged in another order such as “c, b, a” and outputs the reconstructed waveform. The waveform reconstructing section 120 may instead output the received sampling results without changing the order thereof. The waveform reconstructing section 120 can be realized by intersecting the input/output connections. The waveform reconstructing section 120 can switch which output terminal each input terminal is connected to.

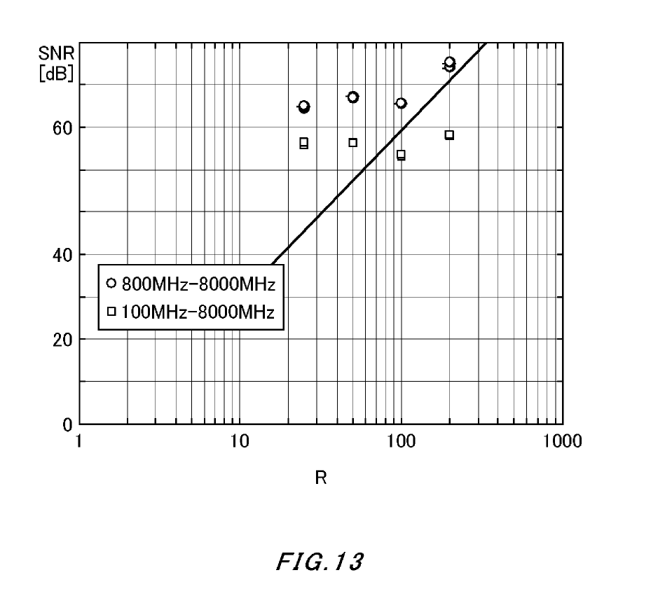

FIG. 13 shows the signal to noise ratio SNR of sampling data acquired by the sampling section 110 shown in FIG. 9. The horizontal axis of FIG. 13 represents the time resolution ratio R of the measurement. Positions that are further to the right on the horizontal axis represent higher time resolution of the measurement. The square marks and circular marks in FIG. 13 represent the measured values of the SNR for each frequency of the signal under measurement.

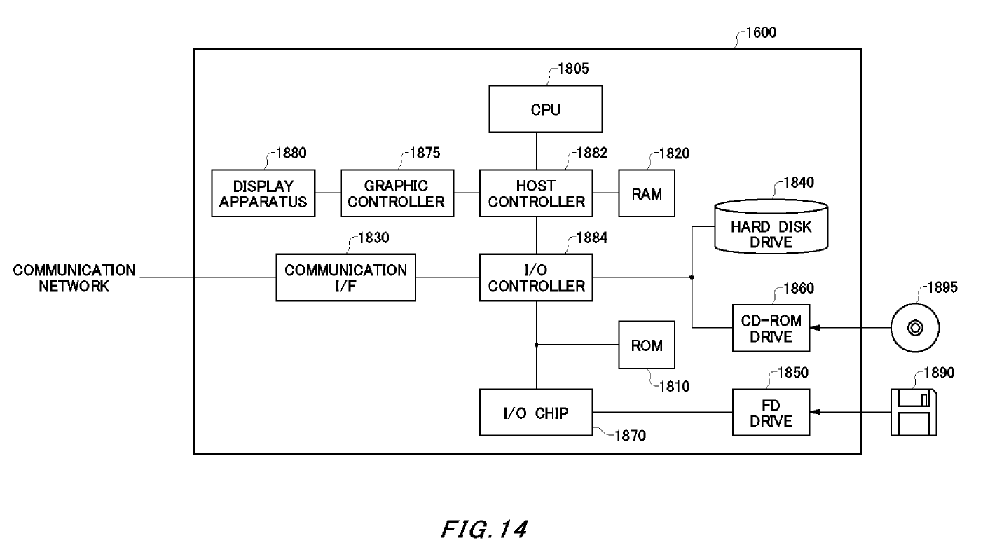

FIG. 14 shows an example of a hardware configuration of a computer 1600 for controlling the measurement apparatus 100. The computer 1600 according to the present embodiment is provided with a CPU peripheral, an input/output section, and a legacy input/output section. The CPU peripheral includes a CPU 1805, a RAM 1820, a graphic controller 1875, and a displaying apparatus 1880, all of which are connected to each other by a host controller 1882.

The input/output section includes a communication interface 1830, a hard disk drive 1840, and a CD-ROM drive 1860, all of which are connected to the host controller 1882 by an input/output controller 1884. The legacy input/output section includes a ROM 1810, a flexible disk drive 1850, and an input/output chip 1870, all of which are connected to the input/output controller 1884.

The host controller 1882 is connected to the RAM 1820 and is also connected to the CPU 1805 and graphic controller 1875 accessing the RAM 1820 at a high transfer rate. The CPU 1805 operates to control each section based on programs stored in the ROM 1810 and the RAM 1820. The graphic controller 1875 acquires image data generated by the CPU 1805 or the like on a frame buffer disposed inside the RAM 1820 and displays the image data in the displaying apparatus 1880. In addition, the graphic controller 1875 may internally include the frame buffer storing the image data generated by the CPU 1805 or the like.

The input/output controller 1884 connects the communication interface 1830 serving as a relatively high speed input/output apparatus, the hard disk drive 1840, and the CD-ROM drive 1860 to the host controller 1882. The hard disk drive 1840 stores the programs and data used by the CPU 1805 housed in the computer 1600. The communication interface 1830 communicates with other apparatuses via a network. The CD-ROM drive 1860 reads the programs and data from a CD-ROM 1895 and provides the read information to the hard disk drive 1840 and the communication interface 1830 via the RAM 1820.

Furthermore, the input/output controller 1884 is connected to the ROM 1810, and is also connected to the flexible disk drive 1850 and the input/output chip 1870 serving as a relatively high speed input/output apparatus. The ROM 1810 stores a boot program performed when the measurement apparatus 100 starts up, a program relying on the hardware of the jitter calculator 10, or the like.

The flexible disk drive 1850 reads programs or data from a flexible disk 1890 and supplies the read information to the hard disk drive 1840 and the communication interface 1830 via the RAM 1820. The input/output chip 1870 connects the flexible disk drive 1850 to each of the input/output apparatuses via, for example, a parallel port, a serial port, a keyboard port, a mouse port, or the like.

The programs executed by the CPU 1805 are stored in a storage medium, such as the flexible disk 1890, the CD-ROM 1895, or an IC card, and provided by a user. The programs stored in the storage medium may be compressed or uncompressed. The programs are read from storage medium, installed in the hard disk drive 1840 via the RAM 1820, and performed by the CPU 1805. The programs executed by the CPU 1805 may cause the measurement apparatus 100 to function as any of the components of the measurement apparatus 100 described in FIGS. 1 to 13. The program may instead cause the computer 1600 to function as the waveform reconstructing section 120.

The programs and modules shown above may also be stored in an external storage medium. The flexible disk 1890, the CD-ROM 1895, an optical storage medium such as a DVD or CD, a magneto-optical storage medium, a tape medium, a semiconductor memory such as an IC card, or the like can be used as the storage medium. Furthermore, a storage apparatus such as a hard disk or RAM that is provided with a server system connected to the Internet or a specialized communication network may be used to provide the programs to the measurement apparatus 100 via the network.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

As made clear from the above, the embodiments of the present invention can be used to quickly calculate a partial waveform that has high resolution and low error.

What is claimed is:

1. A measurement apparatus that measures a signal under measurement having a waveform pattern that repeats with a predetermined cycle, comprising:
a sampling section that coherently samples the signal under measurement; and
a waveform reconstructing section that reconstructs a partial waveform corresponding to a partial region of the waveform pattern, by arranging in a predetermined order pieces of sampling data corresponding to the partial region of the waveform pattern from among sampling data acquired by the sampling section.

2. The measurement apparatus according to claim 1, wherein
the waveform reconstructing section selects the pieces of sampling data corresponding to the partial region from among the sampling data, based on information designating the partial region, and arranges the selected pieces of sampling data in the predetermined order.

3. The measurement apparatus according to claim 2, wherein
the waveform reconstructing section calculates an index prior to reconstruction of the pieces of sampling data corresponding to the partial region, based on inverse conversion information for converting an index indicating the order of each piece of sampling data after reconstruction into an index indicating the order of each piece of sampling data prior to reconstruction, and selects the pieces of sampling data corresponding to the calculated index.

4. The measurement apparatus according to claim 1, wherein
the waveform reconstructing section reconstructs the partial waveform to include an edge portion of the waveform pattern.

5. The measurement apparatus according to claim 1, wherein
the waveform reconstructing section reconstructs the partial waveform to not include an edge portion of the waveform pattern.

6. The measurement apparatus according to claim 4, wherein
the waveform reconstructing section detects a position of the edge portion of the waveform pattern within the cycles based on the sampling data acquired by the sampling section.

7. The measurement apparatus according to claim 6, wherein the waveform reconstructing section includes:
an edge position detecting section that uses a portion of the sampling data acquired by the sampling section to reconstruct the waveform pattern over a region longer than the partial region, and that detects the position of the edge portion of the waveform pattern; and
a partial waveform reconstructing section that selects the pieces of sampling data corresponding to the partial region that includes the position detected by the edge position detecting section, from among the sampling data acquired by the sampling section, and reconstructs the partial waveform corresponding to the partial region.

8. The measurement apparatus according to claim 7, wherein
the waveform reconstructing section further includes a region setting section that sets the partial region to include the position detected by the edge position detecting section and to have a length corresponding to a measurement range of a jitter value of the signal under measurement.

9. The measurement apparatus according to claim 4, further comprising a jitter calculating section that calculates timing jitter of the edge portion based on a positional distribution of the edge portion in a plurality of the partial waveforms.

10. The measurement apparatus according to claim 9, wherein
the jitter calculating section calculates the positional distribution of the edge portion based on a summed waveform obtained by adding together a plurality of the partial waveforms.

11. The measurement apparatus according to claim 1, wherein the sampling section includes:
a plurality of flip-flops that receive the signal under measurement in parallel; and
a plurality of delay elements that are provided to correspond to the flip-flops, that are connected in cascade, and that each sequentially delay a sampling clock input thereto and input the delayed sampling clock into the corresponding flip-flop.

12. A measurement method for measuring a signal under measurement having a waveform pattern that repeats with a predetermined cycle, comprising:
coherently sampling the signal under measurement; and
reconstructing a partial waveform corresponding to a partial region of the waveform pattern, by arranging in a predetermined order pieces of sampling data corresponding to the partial region of the waveform pattern from among the acquired sampling data.

13. A test apparatus that tests a device under test, comprising:
a signal input section that inputs to the device under test a test signal causing the device under test to operate;
the measurement apparatus according to claim 1 that measures the signal under measurement output by the device under test; and
a judging section that judges acceptability of the device under test based on the measurement result of the measurement apparatus.

14. A recording medium storing thereon a program that causes a measurement apparatus to function, the program causing the measurement apparatus to function as the measurement apparatus according to claim 1 that measures a signal under measurement having a waveform pattern that repeats with a predetermined cycle.
